(19) United States
(12) Patent Application Publication
(10) Pub. No.: US 2024/0333190 A1
(43) Pub. Date: Oct. 3, 2024

(54) METHOD FOR OPERATING A MOTOR ARRANGEMENT

(71) Applicant: GKN Automotive Limited, Birmingham (GB)

(72) Inventors: Björn Nemitz, Lohmar (DE); Tobias Weling, Lohmar (DE)

(21) Appl. No.: 18/616,529

(22) Filed: Mar. 26, 2024

(30) Foreign Application Priority Data
Mar. 30, 2023 (DE) 10 2023 108 145.4

(51) Int. Cl. H02P 27/06; H02M 7/5387

(52) U.S. Cl. CPC H02P 27/06; H02M 7/5387

(57) ABSTRACT

The invention relates to a method for operating a motor arrangement which comprises at least one electric motor and an electric circuit for operating the motor with a three-phase rotating current; wherein the motor has at least one stator with at least three coils and a rotor; wherein the circuit comprises at least a first potential connection and a second potential connection which can be connected to different potentials of a DC voltage source; wherein three half-bridges are arranged between the potential connections, which are each assigned to a phase of the rotating current; wherein each coil is electrically conductively connected to a respective half-bridge via a respective first connection and to the other coils via a respective second connection.

### CROSS-REFERENCE TO RELATED APPLICATIONS

This application claims priority to German Application No. DE 10 2023 108 145.4, filed on Mar. 30, 2023, which application is hereby incorporated herein by reference in its entirety.

### BACKGROUND

In principle, an electric motor can be operated in a known manner as a motor and as a generator. The remarks on the motor apply accordingly to the operation as a generator.

Such a circuit regularly comprises at least a first potential connection and a second potential connection (e.g. positive pole and earth), which can be connected to different potentials of a DC voltage source. Three half-bridges are arranged between the potential connections, each of which is assigned to a phase of the three-phase rotating current. Each coil of the motor is electrically conductively connected to a half-bridge via a first connection and to the other coils via a second connection. Connected in series, each half-bridge has an upper switch and a lower switch and has the first connection between the switches. Each switch can be switched between a first position, in which a current can be conducted via the switch, and a second position, in which a conduction of a current is interrupted.

The three half-bridges of the electrical circuit enable the generation of a three-phase-rotating-current-system or multiphase rectangular currents, whereby the phases are offset from each other by 120 angular degrees. Each current or phase current is transferred to a coil or impressed into a coil via a first connection. The coils are connected to each other via second connections, whereby the different phase currents cancel each other out at the star point (common second connection), so that no separate or additional return conductor to the respective other potential connection is required.

A half-bridge comprises an arrangement of an upper transistor and a lower transistor in a known manner, via which the potential connections are connected to each other. In particular, a diode is connected in parallel to each transistor. This design is also referred to as an IGBT-bipolar B, i.e. an insulated-gate bipolar transistor. Alternatively, this circuit can also be implemented using MOSFETs (metal oxide semiconductor field-effect transistors), which can conduct electrical current in both directions.

To operate the motor, a capacitance is usually provided which is connected with the potential connections and arranged in parallel to the half bridges. This capacitance is charged via the DC voltage source and serves to ensure that sufficient power can be called up by the motor at all times.

Safety regulations can apply to such circuits, e.g., in motor vehicles. Accordingly, after a motor vehicle is switched off, for example, or after a crash, electrical components should be discharged immediately, at least until the electrical voltage of the component falls below a limit value, e.g. 60 volts. This discharge should take place within a certain period of time, e.g. 1.95 seconds. A further discharge may then be required, possibly to below 10 volts.

At the same time, the circuit is transferred to a switching state in which the phases of the motor are short-circuited together. For this purpose, all upper switches are switched to the second position and all lower switches to the first position (also referred to as active short circuit—ASC). This generates a current through the motor (the motor acts as a generator). The current is conducted to the circuit and back to the motor, generating counter-torques so that the motor brakes itself. This switching state is also present when the motor is at a standstill, so that no torque is generated and the motor can be held in position under certain circumstances.

The energy stored in the capacitance has so far been converted into heat by electrical resistors. The resistors provided for this purpose should be monitored so that the temperature is not exceeded and any resulting damage to this safety device does not occur.

### SUMMARY

A method for operating a motor arrangement is disclosed. The motor arrangement comprises at least one electric motor and an electric circuit for operating the motor with a three-phase rotating current. The motor has at least one stator with at least three coils and a rotor. The method can also be implemented for two-phase systems, although reference is made here to the generally used three-phase systems.

The circuit comprises at least a first potential connection and a second potential connection, which can be connected or are connected to different potentials of a DC voltage source (e.g. positive pole and earth). Three half-bridges are arranged between the potential connections, each of which is assigned to a phase of the rotating current. Each coil of the motor or stator is electrically connected to a half-bridge via a first connection and to the other coils via a second connection (common star point). Each half-bridge has an upper switch and a lower switch connected in series with each other and the first connection between the switches.

An electrical capacitance is connected to the potential connections and arranged parallel to the half bridges.

Each switch is switchable between a first position, in which a current can be conducted via the switch, and a second position, in which a conduction of a current is interrupted.

The method comprises at least the following step:
a) producing a first switching state of the circuit, in which only one of the upper switches is arranged in the first position and, of the lower switches, only the lower switch, which is assigned to the same half-bridge as the upper switch, is arranged in the second position.

The electric motor can be operated in a known manner as a motor and as a generator. The remarks on the motor apply accordingly to the operation as a generator. The motor is not restricted to any particular configuration.

The electric motor has an electrical power consumption (i.e. a maximum drive power) of 10 watts to 500 kilowatts (rated power). However, other motors can also be used in conjunction with the proposed method.

The three half-bridges of the electrical circuit enable the generation of a three-phase rotating current system or of multi-phase rectangular currents, whereby the phases are offset by 120 degrees to each other. Each current or phase current is transferred to a coil or impressed into a coil via a first connection. The coils are connected to each other via second connections, whereby the different phase currents cancel each other out at the star point (common second connection), so that no separate or additional return conductor to the respective other potential connection is required.

A half-bridge comprises an arrangement of an upper transistor (upper switch) and a lower transistor (lower switch), via which the potential connections are connected to each other, in a known manner. In particular, a diode is connected in parallel to each transistor. This design is also referred to as an IGBT bipolar B, i.e. an insulated-gate bipolar transistor. Alternatively, this circuit can also be implemented using MOSFETs (metal oxide semiconductor field-effect transistors), which can conduct electrical current in both directions. Other switching elements that fulfill the described function can also be used.

Each half-bridge has at least one upper transistor (high-side transistor) as the first switch and one lower transistor (low-side transistor) as the lower switch, whereby these transistors are electrically conductively connected to each other. The upper transistor is electrically conductively connected to the first potential connection and the lower transistor is electrically conductively connected to the second potential connection. Each half-bridge has a contact between the upper transistor and the lower transistor, via which the respective first connection can be connected to the respective half-bridge.

The circuit therefore comprises a first half-bridge, a second half-bridge and a third half-bridge.

The capacitance is realized by a capacitor or by a plurality of capacitors. In a motor vehicle, for example, the capacitance is designed with regard to the performance of the engine and the requirements at hand. The capacitance can, for example, be between 200 and 1,000 μF [microfarads], preferably between 350 and 750 μF, particularly preferably approx. 500 μF.

There are safety regulations for such circuits, e.g. for motor vehicles. Accordingly, after switching off a motor vehicle, for example, or after a crash, electrical components should be discharged immediately, at least until an electrical voltage of the component falls below a limit value, e.g. 60 volts. This discharge should take place within a certain period of time, e.g. 1.95 seconds. A further discharge may then be required, possibly to below 10 volts. The discharge takes place in particular starting from an operating voltage which, for example, is in particular more than 300 volts.

Furthermore, at the same time, the circuit should be transferred to a switching state in which the phases of the motor are short-circuited together (so-called safe state). In known circuits, all upper switches are switched to the second position and all lower switches to the first position (or vice versa, i.e. all upper switches to the first position and all lower switches to the second position). This generates a current through the motor (the motor acts as a generator). The current is conducted to the circuit (to the lower switches of the half bridges) and back to the motor, generating counter-torques so that the motor brakes itself. This switching state is also present when the motor is at a standstill, so that no torque is generated and the motor can be held in position under certain circumstances.

The energy stored in the capacitance has so far been converted into heat in known circuits or methods using electrical resistors specially designed for this purpose. The resistors provided for this purpose should be monitored to ensure that the temperature is not exceeded and that this safety device is not damaged as a result. Discharging via the motor windings has also been possible up to now, but not without simultaneously maintaining the “safe state” described above.

These electrical resistors can be replaced by the disclosed method or their function can be at least partially taken over by the disclosed method. The energy stored in the capacitance is converted by the motor, in particular by its electrical resistance or impedance. The method is used when the motor is rotating (i.e. when the rotor is rotating relative to the stator).

According to step a), a first switching state of the circuit is produced (while the motor is rotating), whereby in this first switching state, for example, only the upper switch of the first half-bridge is arranged in the first position. The upper switches of the other (second and third) half bridges are arranged in the second position. In this first switching state, only the lower switch of the first half-bridge is arranged in the second position, while the lower switches of the other (second and third) half-bridges are arranged in the first position.

As a result of this first switching state (also as a result of the second switching state introduced later), energy can be successively dissipated from the capacitance to the motor. This energy is then successively converted by the motor, e.g. by generating counter-torques that cause the motor to slow itself down and/or by its electrical resistance or impedance.

Step a) (or step b)) only takes place (during the rotation of the rotor or motor) when an electric current is conducted from the potential connections via the phase assigned to this upper switch to the motor. The basically known third switching state is otherwise present, in which all upper switches are in the second position and all lower switches are in the first position (or vice versa). Switching back and forth between the first switching state and the third switching state takes place to dissipate the energy from the capacitance.

A current only flows between the inverter and the motor when, for example, the vehicle is moving and/or switches to the safe-state while still moving and the motor is still rotating accordingly.

When the motor is at a standstill, no currents flow between the motor and the inverter. However, the method described opens the switch between the capacitor and the motor and the voltage difference causes a small current to flow from the capacitor into the motor.

In a step b) following step a), a second switching state is produced in which only one other (than in the first switching state) of the upper switches is arranged in the first position and, of the lower switches, only the lower switch, which is assigned to the same half-bridge as the other upper switch, is arranged in the second position. The respective other upper switches are arranged in the second position and the respective other lower switches are arranged in the first position.

The method therefore comprises carrying out step b) after step a), whereby in this second switching state, for example, if the upper switch of the first half-bridge is arranged in the first position in the first switching state, only the upper switch of the second half-bridge is arranged in the first position. The upper switches of the other (first and third) half bridges are arranged in the second position. In this second switching state, furthermore, only the lower switch of the second half-bridge is arranged in the second position, while the lower switches of the other (first and third) half-bridges are arranged in the first position.

At no time between steps a) and b) are the potential connections connected via one of the half bridges. Thus, at any time between steps a) and b), an electrically conductive connection of the potential connections via one of the half-bridges is prevented or inhibited.

Steps a) and b) are carried out repeatedly, in particular alternately. In particular, at least two or even all three upper or lower switches are switched as described (back and forth between the first and second position).

A third switching state is produced between each first switching state and each second switching state. In the third switching state, all upper switches are in the second position and all lower switches are in the first position. In particular, however, it is also possible to switch back and forth between the first switching state and the second switching state.

Step a) is repeated with the first switching state, i.e. carried out several times in succession (without establishing the second switching state), with a third (or the third) switching state being established in between (i.e. between the first switching states), in which all upper switches are arranged in the second position and all lower switches are arranged in the lower position.

Steps a) and c) or a), b) and c) are carried out (in particular alternately) with a timing that depends on the respective (current) rotational speed of the motor (hereinafter also referred to as the electrical motor frequency). In particular, the aforementioned steps are carried out at a clock rate (frequency) that is at least 2 times, in particular at least 5 times, preferably at least 8 times or even 10 times, higher than the speed of the motor. The frequency of the clocking of the steps is, for example, in a range from 2 to 40 KHz [kilohertz], preferably 8 to 20 kHz, or is preferably approx. 10 KHz.

As a result of the high clock rate and/or frequency between discharging the capacitance via the motor phases (steps a) and b)) and maintaining the active short-circuit of the motor phases (step c)), the electrical function of the active short-circuit can be maintained even at high motor speeds.

A ratio between the execution of steps a) and b) (i.e. within a time interval the sum of the times in which the switching states according to step a) and/or b) are present) and the execution of step c) (i.e. within the time interval the sum of the time in which the switching state c) is present) is at most 1 to 2, i.e. at most 0.5 (step c) is thus present twice longer), in particular at most 1 to 4 (i.e. at most 0.25), preferably at most 1 to 5 (i.e. at most 0.2). In particular, the ratio is in a range from 1 to 2 (i.e. 0.5) to 1 to 10 (i.e. 0.1), preferably in a range from 1 to 3 (i.e. approx. 0.33) to 1 to 7 (i.e. approx. 0.14), particularly preferably in a range from 1 to 4 (i.e. 0.25) to 1 to 5 (i.e. 0.2). The time interval is such that steps a) and/or b) and c) are carried out several times, in particular at least five times each, or even at least 10 times.

At least the first switching state is produced at least (or exclusively) when an electrical discharge of the capacitance is required, e.g. in a motor vehicle when an immediate discharge of the electrical components must take place after switching off or after a crash. In particular, the DC voltage source is no longer connected to the circuit, so that only the energy from the capacitance is (or must be) dissipated via the motor.

At least the first switching state (or also the other switching states described in the manner described) is repeatedly produced until a voltage between the potential connections falls below a limit value. The limit value is in particular less than 100 volts, preferably 60 volts.

Starting from a fully charged capacitance (which is formed, for example, by at least one capacitor) and after the first establishment of at least the first switching state, the limit value is reached after at most two (2) seconds, in particular after at most 1.95 seconds.

It has been shown that the present method can be carried out at a high rotational speed of the motor (rotational speed of the rotor being at least 9,000 revolutions per minute, preferably being at least 10,000, particularly preferably at about 10,500 revolutions per minute) and with the DC voltage source connected and disconnected, whereby no impermissible temperature increase occurs in the circuit at one of the components.

It has also been shown that the present method can also be carried out with the motor at a standstill (rotor speed equal to zero revolutions per minute) and with the DC voltage source connected as well as disconnected, whereby no impermissible temperature increase occurs in the circuit at any of the components.

In the cases with the DC voltage source disconnected, the fully charged capacitance could be reduced to the limit value or below in the required time.

A control device is also disclosed, which is set up to carry out the described method, whereby the control device has exclusively analog electrical switching elements (e.g. signal generator, amplifier, logic operators, gates, etc.), by means of which the at least one first switching state can be produced. All of the described switching states can be produced by the control device. In particular, the control device uses a signal from the motor that is generated by the rotation of the rotor relative to the stator.

The position of the rotor needs to be determined or known, i.e. the position by how many degrees it is rotated. This makes it possible to determine the direction in which the phases are switched or need to be switched in relation to each other. Several signals can be used for this purpose, which—for example—can be tapped from the motor, (e.g. position of the motor). For example, the current on the phases (between inverter and motor) can also be measured and used. There are further possibilities for this in other systems, which are known in principle.

The control device is equipped, configured or programmed in such a way that the electrical circuit can be operated in accordance with the method described.

The control device therefore enables the method to be carried out exclusively by hardware.

A system for data processing is also proposed, whereby the system has means which are suitably configured to carry out the method described.

The means can comprise, for example, a processor and a memory in which instructions to be executed by the processor are stored, as well as data lines or transmission devices which enable the transmission of instructions, measured values, data or the like between the aforementioned elements.

The “means” may include one or more of the following components: controller(s), microcontroller, data memory, data link, display devices (such as a display), counter or timer, at least one other sensor, an energy source, etc.

A non-transitory computer-readable storage medium is further proposed, comprising instructions which, when executed by a computer, cause the computer to carry out the described method or the steps of the described method.

The system thus enables the method to be executed at least partially by software. In particular, the system uses a signal from the motor that is generated by the rotation of the rotor relative to the stator.

As explained above, the position of the rotor is determined or known, i.e. the position by how many degrees it is rotated. This makes it possible to determine the direction in which the phases are or must be switched in relation to each other. Several signals can be used for this purpose, which can, for example, be taken from the motor (e.g. position of the motor). For example, the current on the phases (between the inverter and motor) can also be measured and used. There are further possibilities for this in other systems, which are known in principle.

A motor vehicle is further disclosed, at least comprising a motor arrangement which has at least one electric motor as a traction drive for the motor vehicle and an electric circuit for operating the motor with a three-phase rotating current, the motor vehicle having the control device or system described.

The motor vehicle can be designed as e.g., a car, truck, train, robot, drone, etc.

The disclosed examples of the method are transferable to the motor vehicle, the control device, the system for data processing and/or the computer-implemented method (i.e. the computer program and the computer-readable storage medium) and vice versa.

It should be noted that the number words used here (“first”, “second”, etc.) primarily serve (only) to differentiate between several similar objects, variables, or processes, i.e., they do not necessarily specify any dependency and/or sequence of these objects, variables, or processes in relation to one another. If a dependency and/or sequence is required, this is explicitly stated here, or is self-evident to the person skilled in the art when studying the described configurations.

### BRIEF SUMMARY OF THE DRAWINGS

The disclosure is explained in more detail below with reference to the figures. It should be noted that the claims are not intended to be limited by the design examples shown. In particular, unless explicitly shown otherwise, it is also possible to extract partial aspects of the features explained in the figures and to combine them with other components and findings from the present description and/or figures. Identical reference signs denote identical objects, so that explanations from other figures can be used as a supplement if necessary.

FIG. 1: shows a known motor arrangement and a known method of operation;

FIG. 2: shows a simplified representation of the motor arrangement according to FIG. 1;

FIG. 3: shows a motor arrangement with a circuit in a first switching state;

FIG. 4: shows another representation of the motor arrangement according to FIG. 3;

FIG. 5: shows a first diagram;

FIG. 6: shows a second diagram; and

FIG. 7: shows the motor arrangement according to FIGS. 3 and 4 with a circuit in a second switching state.

### DESCRIPTION

The present disclosure relates to a method for operating a motor arrangement. The motor arrangement comprises at least one electric motor and an electric circuit for operating the motor with a three-phase rotating current. The motor has at least one stator with at least three coils and a rotor. In particular, an alternative solution for dissipating the energy stored in the capacitance is disclosed.

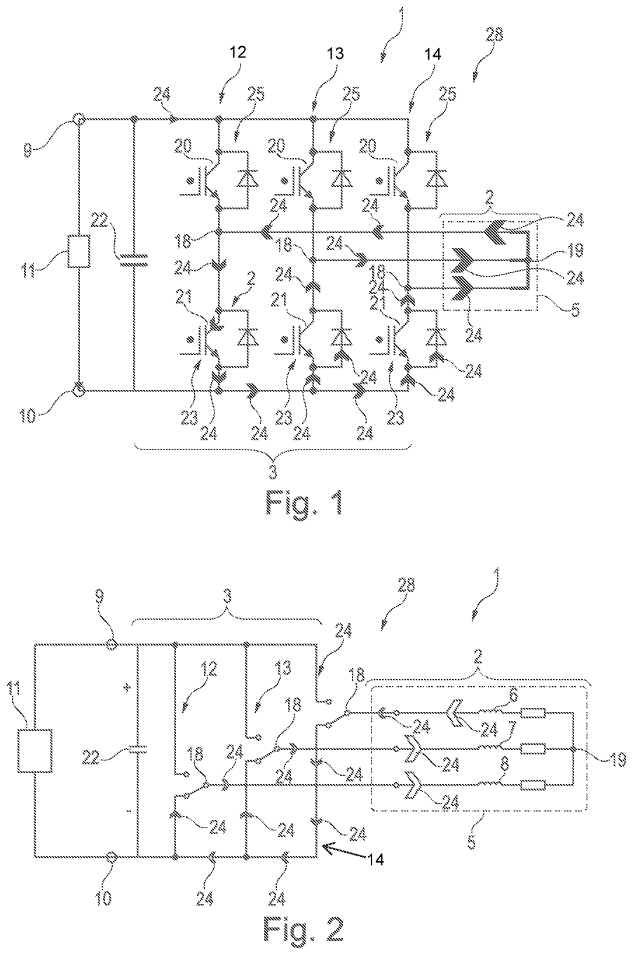

FIG. 1 shows a known motor arrangement 1 and a known method of operation. FIG. 2 shows a simplified representation of the motor arrangement 1 according to FIG. 1. FIGS. 1 and 2 are described together below.

The motor arrangement 1 comprises an electric motor 2, which has a stator 5 with three coils 6, 7, 8 and a rotor (not shown), as well as an electric circuit 3. The motor 2 can be operated via the electric circuit 3.

The known electrical circuit 3 for driving an electric motor 2 comprises a first potential connection 9 and a second potential connection 10, which are connected to different potentials (e.g. positive pole and earth) of a DC voltage source 11, three half-bridges 12, 13, 14 being provided between the potential connections 9, 10, each coil 6, 7, 8 of the electric motor 2 being electrically conductively connected to a respective half-bridge 12, 13, 14 via a respective first connection 18 and to the other end of coils 6, 7, 8 via a respective second connection 19 (common star point).

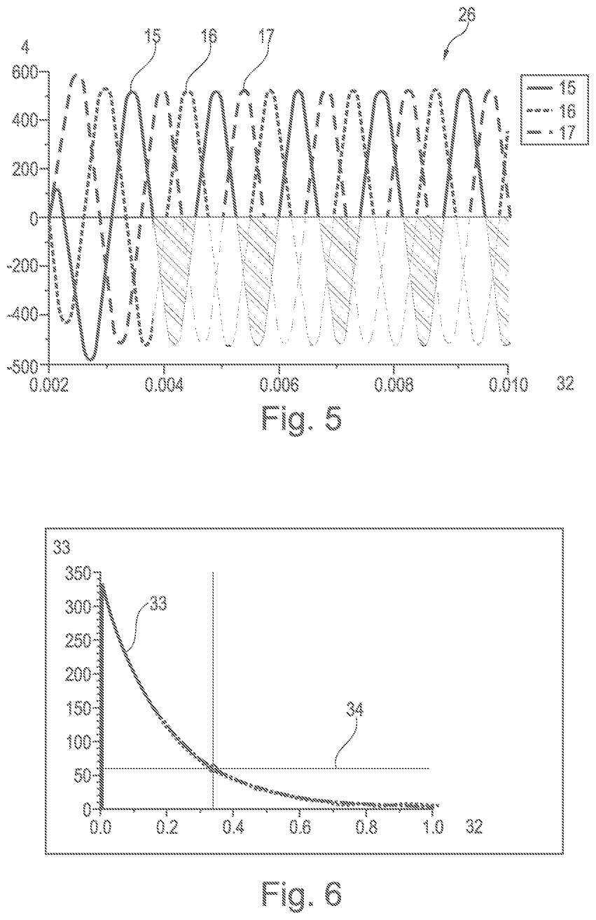

The three half-bridges 12, 13, 14 of the electrical circuit 3 enable the generation of a three-phase rotating current system, i.e. a three-phase current 4, in which the phases 15, 16, 17 are offset from each other by 120 angular degrees (see FIG. 5). Each phase 15, 16, 17 is transmitted to a coil 6, 7, 8 via a first connection 18. The coils 6, 7, 8 are connected to each other via second connections 19, whereby the different phases 15, 16, 17 of the three-phase current 4 cancel each other out at the star point, so that no return conductor to the other potential connection 9, 10 is required.

A half bridge 12, 13, 14 comprises, in a known manner, an arrangement of an upper transistor as upper switch 20 and a lower transistor as lower switch 21, via which the potential connections 9, 10 are connected to each other. A diode is connected in parallel to each transistor (see FIG. 1). The first connections 18 are electrically connected to the respective half-bridge 12, 13, 14.

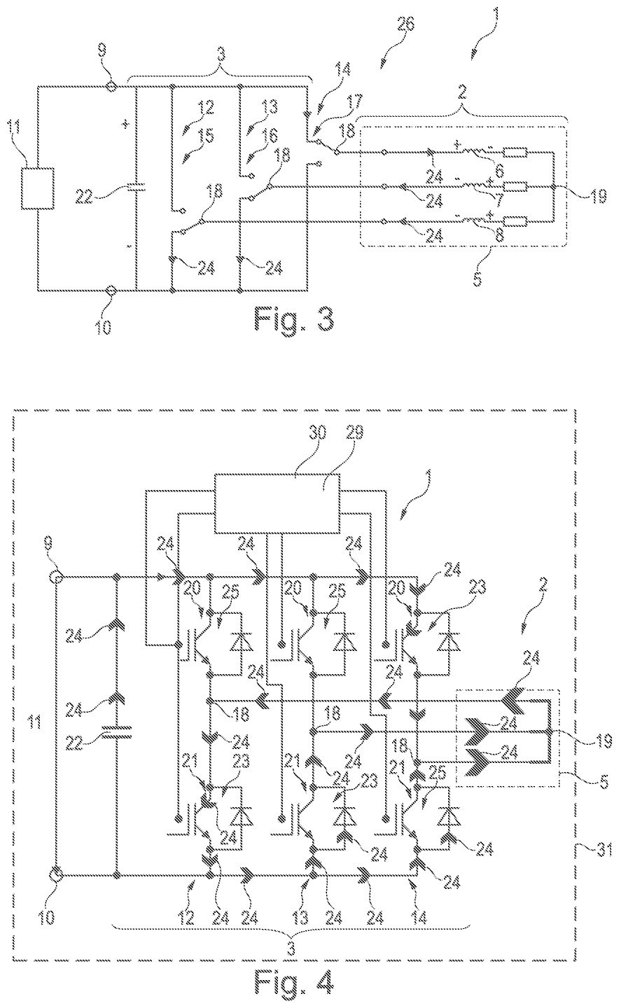

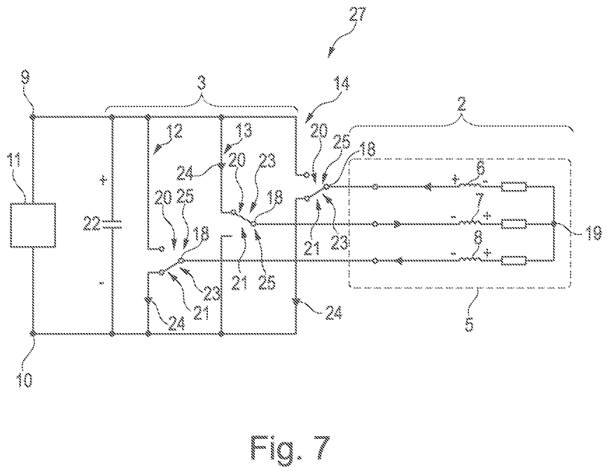

In the illustration in FIG. 2 (and also in FIGS. 3 and 7), the transistors and diodes or upper switches 20 and lower switches 21 are shown in simplified form as individual switches. Each coil 6, 7, 8 is formed by an electrical resistor R and an electrical inductance L.

For the operation of the motor 2, a capacitance 22 is regularly provided, which is connected in parallel to the half bridges 12, 13, 14 with the potential connections 9, 10. This capacitance 22 is charged via the DC voltage source 11 and serves to ensure that sufficient power can be called up by the motor 2 at all times.

Safety regulations apply to such circuits 3, particularly in motor vehicles 31. Accordingly, after switching off a motor vehicle 31 or after a crash, for example, an immediate discharge of electrical components, e.g. the capacitance 22, should take place, at least until an electrical voltage 33 (see FIG. 6) of the component falls below a limit value 34, e.g. 60 volts. This discharge should take place within a certain period of time.

At the same time, the circuit 3 is transferred to a (third) switching state 28, in which the phases 15, 16, 17 of the motor 2 are short-circuited together. For this purpose, all upper switches 20 are switched to the second position 25 and all lower switches 21 are switched to the first position 23, so that the phases 15, 16, 17 of the motor 2 are short-circuited. This generates a current 24 through the motor 2 (the motor 2 acts as a generator). The current 24 is conducted to the circuit 3 and back to the motor 2, generating counter-torques so that the motor 2 brakes itself.

The energy stored in the capacitance 22 is previously converted into heat by electrical resistors (not shown here, the at least one resistor is then connected in parallel to the capacitance 22). The resistors provided for this purpose should be monitored so that the temperature is not exceeded and any resulting damage to this safety device does not occur.

In the third switching state 28 shown in FIGS. 1 and 2, all upper switches 20 are in the second position 25 and all lower switches 21 are in the first position 23.

FIG. 3 shows a motor arrangement 1 with a circuit 3 in a first switching state 26. FIG. 4 shows the motor arrangement 1 according to FIG. 3 in a different position. FIGS. 3 and 4 are described together below. Reference is made to the explanations of FIGS. 1 and 2.

In the illustration in FIG. 3, the transistors and diodes or upper switches 20 and lower switches 21 are shown in simplified form as individual switches.

The motor arrangement 1 comprises an electric motor and an electric circuit 3 for operating the motor 2 with a three-phase rotating current 4. The motor 2 has a stator 5 with three coils 6, 7, 8 and a rotor (not shown).

The circuit 3 comprises a first potential connection 9 and a second potential connection 10, which are connected to different potentials of a DC voltage source 11 (e.g. positive pole and earth). Three half-bridges 12, 13, 14 are arranged between the potential connections 9, 10, each of which is assigned to a phase 15, 16, 17 of the three-phase current 4. Each coil 6, 7, 8 of the motor 2 or stator 5 is electrically conductively connected to a respective half bridge 12, 13, 14 via a first connection 18 and to the other end of coils 6, 7, 8 via a respective second connection 19 (common star point). Each half-bridge 12, 13, 14 has an upper switch 20 and a lower switch 21 connected in series with each other and the first connection 18 between the switches 20, 21.

An electrical capacitance 22 (capacitor) is connected in parallel to the half bridges 12, 13, 14 with the potential connections 9, 10.

Each switch 20, 21 is switchable between a first position 23, in which a current 24 can be conducted via the switch 20, 21, and a second position 25, in which a conduction of a current 4 is interrupted.

It is proposed here that the electrical resistors described in connection with FIGS. 1 and 2 are replaced by the disclosed method or that their function is at least partially taken over by the disclosed method. The energy stored in the capacitance 22 is converted by the motor 2, in particular by its electrical resistance or impedance.

According to step a), a first switching state 26 of the circuit 3 is produced, whereby in this first switching state 26 only the upper switch 20 of the third half-bridge 14 is arranged in the first position 23. The upper switches 20 of the other, first and second, half bridges 12, 13 are arranged in the second position 25. In this first switching state 26, furthermore, of the lower switches 21 only the lower switch 21 of the third half-bridge 14 is arranged in the second position 25, while the lower switches 21 of the other, first and second, half-bridges 12, 13 are arranged in the first position 23.

As a result of this first switching state 26 (also through the second switching state 27 shown in FIG. 7), energy can be successively dissipated from the capacitance 22 to the motor 2. This energy is then successively converted by the motor 2, e.g. by generating counter-torques that cause the motor 2 to slow itself down and/or by its electrical resistance or impedance.

FIG. 4 indicates that the motor arrangement 1 is part of a motor vehicle 31, which has at least one electric motor 2 as a traction drive for the motor vehicle 31 and an electric circuit 3 for operating the motor 2 with a three-phase rotating current 4, whereby the motor vehicle 31 has a control device 29 or a system 30.

The switches 20, 21 can be actuated via the control device 29 exclusively via analog electrical switching elements, by which the different switching states 26, 27, 28 can be produced. The control device 29 uses a signal from the motor 2 that is generated by the rotation of the rotor relative to the stator 5.

FIG. 5 shows a first diagram. The three-phase current 4 is plotted in amperes on the vertical axis. The time 32 is plotted in seconds on the horizontal axis. The curves shown represent the first phase 15, the second phase 16 and the third phase 17.

The curves of phases 15, 16 and 17 are shown during the first switching state 26 of motor arrangement 1 as shown in FIGS. 3 and 4. These signals (curves of phases 15, 16, 17) can be detected at phases 15, 16, 17 between the inverter and motor 2, e.g. at connection 18.

The three half-bridges 12, 13, 14 of the electrical circuit 3 enable the generation of a three-phase rotating current 4 or multi-phase rectangular currents, whereby the phases 15, 16, 17 are offset by 120 degrees to each other. Each current 4 or phase current is transmitted to a coil 6, 7, 8 via a first connection 18 and/or impressed into a coil 6, 7, 8.

The first switching state 26 according to step a) only occurs during the rotation of the rotor or motor 2 if an electric current 24 is conducted from the potential connections 8, 9 via the first phase 15 assigned to this upper switch 20 of the first half-bridge 12 to the motor 2. In particular, the basically known third switching state 28 is otherwise present, in which all upper switches 20 are arranged in the second position 25 and all lower switches 21 are arranged in the first position 23. To dissipate the energy from the capacitance 22, switching back and forth between the first switching state 26 and the third switching state 28 therefore takes place. The dissipated energy or the current 4 dissipated from the capacitance 22 to the motor 2 is shown here in each case as a hatched area.

FIG. 6 shows a second diagram. The voltage 33 is plotted in volts on the vertical axis. The time 32 is plotted in seconds on the horizontal axis. The curve shown represents the drop in voltage 33 as soon as the first switching state 26 is produced for the first time and then repeatedly. It can be seen that the limit value 34 of 60 volts is reached within 0.34 seconds.

The voltage 33 is determined at the capacitance 22, i.e. between the potential connections 9, 10 (with the DC voltage source 11 disconnected).

FIG. 7 shows the motor arrangement according to FIGS. 3 and 4 with a circuit in a second switching state 27. Reference is made to the comments on FIGS. 1 to 6, in particular FIGS. 3 and 4.

The second switching state 27 is produced in a step b), whereby only one other (than in the first switching state 26) of the upper switches 20, here the upper switch 20 of the second half-bridge 13, is arranged in the first position 23 and of the lower switches 21 only the lower switch 21, which is assigned to the second half-bridge 13, is arranged in the second position 25. The respective further upper switches 20 of the first and third half-bridges 12, 14 are arranged in the second position 25 and the respective further lower switches 21 of the first and third half-bridges 12, 14 are arranged in the first position 25.

### LIST OF REFERENCE SYMBOLS

1 motor arrangement
2 motor
3 circuit
4 three-phase current
5 stator
6 first coil
7 second coil
8 third coil
9 first potential connection
10 second potential connection
11 DC voltage source
12 first half-bridge
13 second half-bridge
14 third half-bridge
15 first phase
16 second phase
17 third phase
18 first connection
19 second connection
20 upper switch
21 lower switch
22 capacitance
23 first position
24 current
25 second position
26 first switching state
27 second switching state
28 third switching state
29 control device
30 system
31 motor vehicle
32 time
33 voltage
34 limit value

1-12. (canceled)

13. A method of operating a motor arrangement which comprises at least one electric motor and an electric circuit for operating the motor with a three-phase rotating current; the motor having at least one stator with at least three coils and a rotor; wherein the circuit comprises at least a first potential connection and a second potential connection, which can be connected to different potentials of a DC voltage source; wherein three half-bridges are arranged between the potential connections, which are each assigned to a phase of the rotating current; wherein each coil is electrically conductively connected to a respective half-bridge via a respective first connection and to the other coils via a respective second connection; wherein each half-bridge has an upper switch and a lower switch connected in series with one another and the first connection between the switches; wherein an electrical capacitance is connected in parallel with the half bridges to the potential connections; wherein each switch is switchable between a first position, in which a current can be conducted via the switch, and a second position, in which conduction of a current is interrupted; the method comprising:
a) producing a first switching state of the circuit, in which only one of the upper switches is arranged in the first position and, of the lower switches, only the lower switch, which is assigned to the same half-bridge as the upper switch, is arranged in the second position.

14. The method according to claim 13, wherein step a) only takes place when the electric current is conducted from the potential connections via the phase, which is assigned to the one upper switch, to the motor.

15. The method according to claim 13, wherein in a step b), which follows step a), a second switching state is produced, in which only another of the upper switches is arranged in the first position and of the lower switches only the lower switch, which is assigned to the same half-bridge as the other upper switch, is arranged in the second position.

16. The method according to claim 15, wherein at any time between steps a) and b) an electrically conductive connection of the potential connections via one of the half-bridges is prevented.

17. The method according to claim 13, wherein step a) is repeated with the first switching state and c) producing a third switching state in between, in which all upper switches are arranged in the second position and all lower switches are arranged in the first position.

18. The method according to claim 17, wherein within a time interval, in which the steps a) and c) are each carried out several times, a ratio between a duration of the execution of step a) and the execution of step c) is at most 0.5.

19. The method according to claim 13, wherein at least the first switching state is produced at least when an electrical discharge of the capacitance is required.

20. The method according to claim 19, wherein at least the first switching state is produced until a voltage between the potential connections falls below a limit value.

21. The method according to claim 20, wherein, starting from a fully charged capacitance and after a first establishment of the first switching state, the limit value is reached after at most two seconds.

22. A system, comprising:
an electric motor and an electric circuit for operating the motor with a three-phase rotating current; the motor having a stator with at least three coils and a rotor; wherein the circuit comprises a first potential connection and a second potential connection, which can be connected to different potentials of a DC voltage source; wherein three half-bridges are arranged between the potential connections, which are each assigned to a phase of the rotating current; wherein each coil is electrically conductively connected to a respective half-bridge via a respective first connection and to the other coils via a respective second connection; wherein each half-bridge has an upper switch and a lower switch connected in series with one another and the first connection between the switches; wherein an electrical capacitance is connected in parallel with the half bridges to the potential connections; wherein each switch is switchable between a first position, in which a current can be conducted via the switch, and a second position, in which conduction of a current is interrupted; a processor; and a memory, the memory including instructions executable by the processor to: a) arrange only one of the upper switches in the first position and, of the lower switches, arrange only the lower switch assigned to the same half-bridge as the one upper switch in the second position.

23. The system according to claim 22, wherein the instructions further comprise instructions to execute step a) only when the electric current is conducted from the potential connections via the phase, which is assigned to the one upper switch, to the motor.

24. The system according to claim 22, wherein the instructions further comprise instructions to: b) arrange only another one of the upper switches in the first position and, of the lower switches, arrange only the lower switch assigned to the same half-bridge as the other upper switch in the second position.

25. The system according to claim 24, wherein the instructions further comprise instructions to prevent, at any time between steps a) and b), an electrically conductive connection of the potential connections via one of the half-bridges.

26. The system according to claim 22, wherein the instructions further comprise instructions to: c) arrange all the upper switches in the second position and arrange all the lower switches in the first position and repeat steps a) and c).

27. The A system according to claim 26, wherein the instructions further comprise instructions to: within a time interval in which the steps a) and c) are each carried out several times, provide a ratio between a duration of the execution of step a) and the execution of step c) that is at most 0.5.

28. The system according to claim 22, wherein the instructions further comprise instructions to execute step a) to electrically discharge the capacitance.

29. The system according to claim 28, wherein the instructions further comprise instructions to execute step a) until a voltage between the potential connections falls below a limit value.

30. The system according to claim 29, wherein the instructions further comprise instructions to reach the limit value from a fully charged capacitance within two seconds of executing step a).

31. A motor vehicle, comprising:
a motor arrangement having an electric motor as a traction drive for the motor vehicle and an electric circuit for operating the motor with a three-phase rotating current, the electric motor having a stator with at least three coils and a rotor; wherein the electric circuit comprises a first potential connection and a second potential connection, which can be connected to different potentials of a DC voltage source; wherein three half-bridges are arranged between the potential connections, which are each assigned to a phase of the rotating current; wherein each coil is electrically conductively connected to a respective half-bridge via a respective first connection and to the other coils via a respective second connection; wherein each half-bridge has an upper switch and a lower switch connected in series with one another and the first connection between the switches; wherein an electrical capacitance is connected in parallel with the half bridges to the potential connections; wherein each switch is switchable between a first position, in which a current can be conducted via the switch, and a second position, in which conduction of a current is interrupted; a processor; and a memory, the memory including instructions executable by the processor to: arrange only one of the upper switches in the first position and, of the lower switches, arrange only the lower switch assigned to the same half-bridge as the only one upper switch in the second position.
